(19) United States
(12) Patent Application Publication
(10) Pub. No.: US 2014/0077770 A1
(43) Pub. Date: Mar. 20, 2014

(54) POWER FACTOR CORRECTION CIRCUIT CONTROLLING DEVICE AND CHARGING DEVICE

(71) Applicants: Yasumichi Omoto, Aichi (JP); Yoshihiro Ikushima, Aichi (JP); Yusaku Ido, Gifu (JP)

(72) Inventors: Yasumichi Omoto, Aichi (JP); Yoshihiro Ikushima, Aichi (JP); Yusaku Ido, Gifu (JP)

(73) Assignee: OMRON AUTOMOTIVE ELECTRONICS CO., LTD., Aichi (JP)

(21) Appl. No.: 14/030,163

(22) Filed: Sep. 18, 2013

(30) Foreign Application Priority Data
Sep. 18, 2012 (JP) 2012-204143

(51) Int. Cl. H02M 7/217; H02J 7/00

(52) U.S. Cl. CPC H02M 7/217; H02J 7/007
USPC 320/140; 363/44

(57) ABSTRACT

A power factor correction circuit controlling device has a power factor correction circuit that is connected to an AC power supply, and brings a waveform of an input current from the AC power supply close to a sine wave to correct a power factor by an on/off operation of a switching element, and a controller that controls an operation of the power factor correction circuit. The power factor correction circuit includes a current detection circuit that detects the input current, and a voltage detection circuit that detects the output voltage at the power factor correction circuit.

### BACKGROUND

1. Technical Field

The present invention relates to a technology of controlling a power factor correction circuit that brings a waveform of an input current close to a waveform of an input voltage to correct a power factor.

2. Related Art

An electric automobile or a hybrid car is equipped with a high-voltage battery of a driving source for a running motor, and is provided with a charging device in order to charge the high-voltage battery (for example, see Japanese Unexamined Patent Publication Nos. 2009-247101 and 2010-88150). Usually the charging device includes a power factor correction circuit (hereinafter referred to as a PFC (Power Factor Correction) circuit).

FIG. 18 illustrates an example of the PFC circuit. A PFC circuit 60 is a well-known circuit including an inductor L3, a diode D5, a capacitor C1, and a switching element Q3. For example, the switching element Q3 is constructed by a MOS-FET, and turned on and off by a pulse signal from a controller 70 to perform a switching operation. A current waveform similar to a voltage waveform (a sine wave) is generated by the switching operation, and the current waveform comes close to the sine wave to correct a power factor. At this point, the inductor L3 and the diode D5 perform boost (or step-down) of the voltage and an AC-DC conversion.

In the PFC circuit 60, the controller 70 controls an on/off operation of the switching element Q3 such that a predetermined voltage is outputted. Therefore, an input voltage and an input current of the PFC circuit 60 are detected by a voltage detection circuit (not illustrated) and a current detection circuit (not illustrated), and the controller 70 controls the switching element Q3 based on detection values of the input voltage and input current. At this point, for example, an input side of the PFC circuit 60 has a voltage as high as 100 to 200 V, while the side of the controller 70 has a voltage as low as 5 V. In order to prevent a mistaken passage of the current on the high-voltage side through the side of the controller 70, it is necessary to provide electrical insulation between the controller 70 and the voltage detection circuit that detects the input voltage. Therefore, it is necessary to provide components such as an isolated amplifier, and it is also necessary to ensure an insulation distance, which disturbs downsizing and cost reduction.

### SUMMARY

One or more embodiments of the present invention provides a power factor correction circuit controlling device that can perform the desired operation even if the voltage detection circuit that detects the input voltage is not provided.

In accordance with one or more embodiments of the present invention, a power factor correction circuit controlling device includes: a power factor correction circuit that is connected to an AC power supply, and brings a waveform of an input current from the AC power supply close to a sine wave to correct a power factor by an on/off operation of a switching element; and a controller that controls an operation of the power factor correction circuit. The power factor correction circuit includes: a current detection circuit that detects the input current; and a voltage detection circuit that detects an output voltage at the power factor correction circuit. During start-up of the power factor correction circuit, the controller fixes the switching element to an on state, analyzes the waveform of the input current passing through the switching element from the AC power supply based on an output of the current detection circuit, and performs initial processing of determining an input voltage at the power factor correction circuit based on the analysis result. After the initial processing, the controller controls an on/off operation of the switching element based on the determined input voltage, the input current detected by the current detection circuit, and the output voltage detected by the voltage detection circuit.

In the power factor correction circuit controlling device according to one or more embodiments of the present invention, during the start-up of the power factor correction circuit, the controller analyzes the waveform of the input current, determines the input voltage based on the analysis result, and controls the power factor correction circuit based on the input voltage. Therefore, even if the voltage detection circuit that detects the input voltage is not provided, the input voltage is determined using the originally-provided input current detection circuit, and the desired power factor correction operation can be performed. Accordingly, unlike the conventional technology, it is not necessary to provide the components such as the isolated amplifier, and it is not necessary to ensure the insulation distance.

In the power factor correction circuit controlling device, the controller may determine a voltage level, a frequency, and reference timing synchronized with the sine wave with respect to the input voltage when analyzing the waveform of the input current. Additionally the controller may further determine sign criteria synchronized with positive and negative values of the sine wave.

In the power factor correction circuit controlling device, in determining the reference timing, the controller may fix a starting clock time of the sine wave after fixing a commercial frequency.

In the power factor correction circuit controlling device, the controller may include: a voltage phase compensator that compares a present output voltage at the power factor correction circuit to a target voltage, and performs voltage phase compensation based on a deviation between the present output voltage and the target voltage; a multiplier that shapes the sine wave based on an output of the voltage phase compensator and the input voltage; a current phase compensator that compares a present input current of the power factor correction circuit to an output of the multiplier, and performs current phase compensation based on a deviation between the present input current and the output of the multiplier; and a pulse modulator that generates a PWM signal having a duty corresponding to an output of the current phase compensator, and outputs the PWM signal to the switching element.

In the power factor correction circuit controlling device, the controller may update the determined reference timing under a given condition. For example, the controller may monitor the waveform of the input current based on the output of the current detection circuit, and correct phase shifting to update the reference timing when a phase is advanced or delayed in the current waveform.

In the power factor correction circuit controlling device, the controller may determine the input voltage based on the analysis result of the output voltage waveform instead of determining the input voltage based on the analysis result of the input current waveform.

In accordance with one or more embodiments of the present invention, a charging device includes: the power factor correction circuit controlling device; and a DC-DC converter that generates a charging DC voltage by performing DC-DC conversion of a voltage outputted from the power factor correction circuit.

Accordingly, one or more embodiments of the present invention can provide the power factor correction circuit controlling device that can perform the desired operation even if the voltage detection circuit that detects the input voltage is not provided.

### BRIEF DESCRIPTION OF THE DRAWINGS

FIG. 1 is a block diagram illustrating one or more embodiments of the present invention;

FIG. 2 is a view illustrating a current route during initial processing;

FIGS. 3A to 3I are views illustrating a signal waveform and a detection value of each part in FIG. 2;

FIG. 4 is a flowchart illustrating an outline of a control procedure;

FIG. 5 is a flowchart illustrating a detailed procedure of the initial processing;

FIGS. 6A to 6C are views illustrating a determination of a voltage level in sine wave analysis processing;

FIGS. 7A to 7C are views illustrating a determination of a frequency in the sine wave analysis processing;

FIGS. 8A and 8B are block diagrams illustrating a function of a controller;

FIG. 9 is a flowchart illustrating a procedure of reference timing determination processing;

FIG. 10 is a view illustrating a determination of reference timing synchronized with a sine wave;

FIG. 11 is a view illustrating sign criteria synchronized with positive and negative values of the sine wave;

FIG. 12 is a flowchart illustrating a detailed procedure of normal PFC control;

FIG. 13 is a view illustrating a table used to synthesize the sine wave;

FIG. 14 is a flowchart illustrating a procedure of ending processing;

FIGS. 15A to 15C are views illustrating an update of the reference timing;

FIG. 16 is a block diagram when one or more embodiments of the present invention is applied to a charging device;

FIG. 17 is a circuit diagram illustrating a specific example of a DC-DC converter in FIG. 16; and

FIG. 18 is a circuit diagram illustrating a conventional example.

### DETAILED DESCRIPTION

Embodiments of the present invention will be described with reference to the drawings. In the drawings, the identical or equivalent component is designated by the identical numeral. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

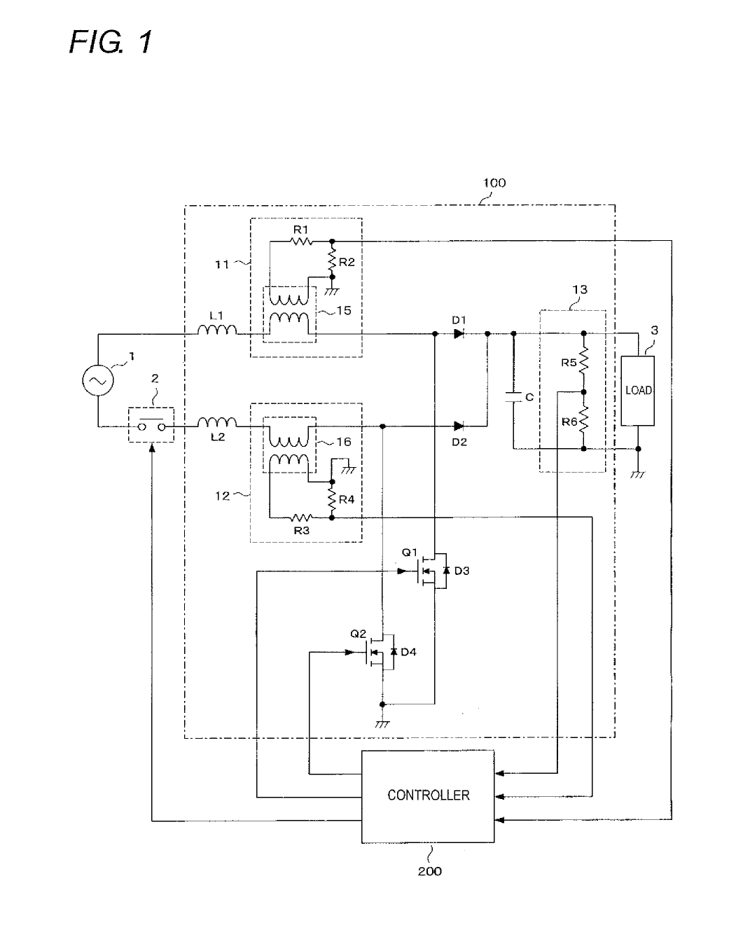

A configuration of one or more embodiments will be described with reference to FIG. 1. In FIG. 1, a PFC (Power Factor Correction) circuit 100 is provided between an external AC power supply 1 and a load 3, and a controller 200 controls an operation of the PFC circuit 100. For example, the AC power supply 1 is a commercial power supply of AC 100 V. An inrush current preventing relay 2 is connected between the AC power supply 1 and the PFC circuit 100. The controller 200 controls opening and closing of the relay 2. The controller 200 is constructed by a microcomputer. The load 3 is connected to an output terminal of the PFC circuit 100.

The PFC circuit 100 includes inductors L1 and L2, diodes D1 and D2, a capacitor C, switching elements Q1 and Q2, current detection circuits 11 and 12, and a voltage detection circuit 13. One end of the inductor L1 is connected to one end of the AC power supply 1, and the other end of the inductor L1 is connected to the current detection circuit 11. One end of the inductor L2 is connected to the other end of the AC power supply 1 through the relay 2, and the other end of the inductor L2 is connected to the current detection circuit 12. The diode D1 is provided between the current detection circuit 11 and the voltage detection circuit 13. The diode D2 is provided between the current detection circuit 12 and the voltage detection circuit 13. One end of the capacitor C is connected to a cathode of the diodes D1 and D2, and the other end of the capacitor C is grounded.

For example, the switching elements Q1 and Q2 are constructed by MOS-FETs, and diodes D3 and D4 are connected in parallel with the switching elements Q1 and Q2, respectively. A drain of the switching element Q1 is connected to an anode of the diode D1, and a source of the switching element Q1 is grounded. The drain of the switching element Q2 is connected to the anode of the diode D2, and the source of the switching element Q2 is grounded. A PWM (Pulse Width Modulation) signal is provided from the controller 200 to a gate of each of the switching elements Q1 and Q2. The switching elements Q1 and Q2 are turned on and off by the PWM signal to perform a switching operation.

The current detection circuits 11 and 12 detect input currents from the AC power supply 1. The current detection circuit 11 includes a transformer 15 and resistors R1 and R2. A primary side winding of the transformer 15 is provided between the inductor L1 and the diode D1. The resistors R1 and R2 are connected to a secondary side winding of the transformer 15. An output of the current detection circuit 11 is inputted to the controller 200. The current detection circuit 12 includes a transformer 16 and resistors R3 and R4. The primary side winding of the transformer 16 is provided between the inductor L2 and the diode D2. The resistors R3 and R4 are connected to the secondary side winding of the transformer 16. The output of the current detection circuit 12 is also inputted to the controller 200.

The voltage detection circuit 13 detects an output voltage at the PFC circuit 100, and includes series-connected resistors R5 and R6. The resistors R5 and R6 are divider resistors that divide the output voltage at the PFC circuit 100. The voltage (a voltage-dividing voltage) at a connection point of the resistors R5 and R6 is inputted to the controller 200.

In the PFC circuit 100, the current waveform similar to the voltage waveform (a sine wave) of the input voltage supplied from the AC power supply 1 is generated by the switching operations of the switching elements Q1 and Q2, and the current waveform comes close to the sine wave to correct the power factor. At this point, the inductors L1 and L2 and the diodes D1 and D2 perform boost of the voltage and rectification (an AC-DC conversion).

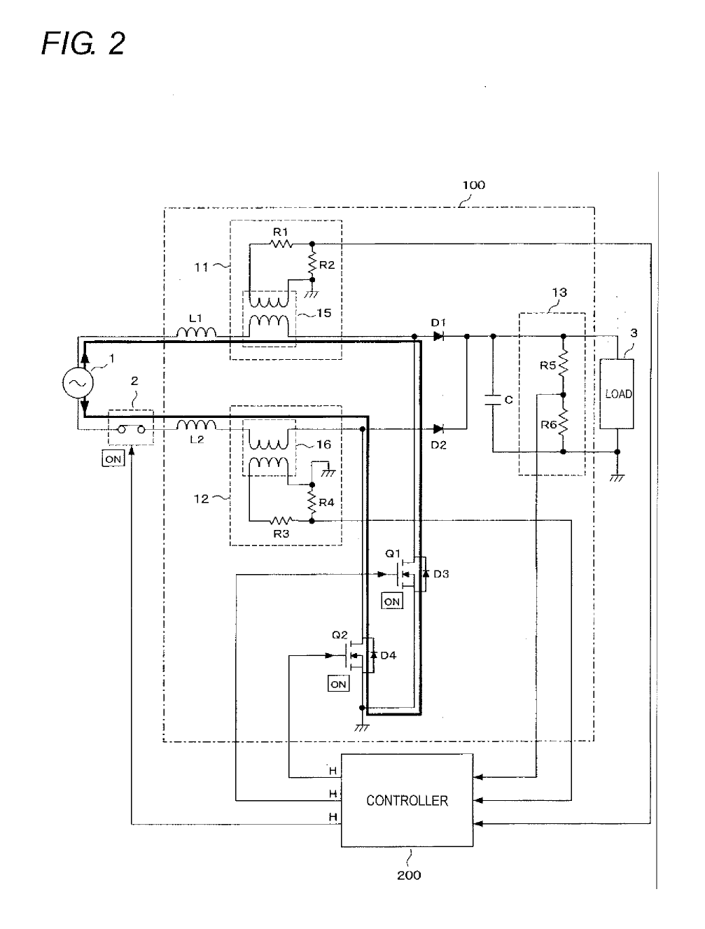

A basic principle according to one or more embodiments of the present invention will be described below. A technique, in which the input voltage is determined with the originally-provided current detection circuits 11 and 12 that detect the input currents without providing a voltage detection circuit that detects the input voltage at the PFC circuit 100, is adopted in one or more embodiments of the present invention. Therefore, during start-up of the PFC circuit 100, the switching elements Q1 and Q2 are fixed to an on state to perform initial processing of determining the input voltage as illustrated in FIG. 2. The detailed initial processing is described later.

Referring to FIG. 2, the controller 200 outputs an H (High)-level signal to the relay 2, and turns on the relay 2 to close a contact. The H-level signal is outputted to the gates of the switching elements Q1 and Q2 from the controller 200 to put the switching elements Q1 and Q2 into the on state. In the state in which the switching elements Q1 and Q2 are fixed to the on state, the input current is passed through the inductors L1 and L2, the current detection circuits 11 and 12, the switching elements Q1 and Q2, and the relay 2 from the AC power supply 1 as indicated by a thick line.

Particularly, when the side of the inductor L1 of the AC power supply 1 is at a positive potential, the input current is passed through a route of AC power supply 1, inductor L1, primary winding of transformer 15 of current detection circuit 11, switching element Q1, diode D4, primary winding of transformer 16 of current detection circuit 12, inductor L2, relay 2, to AC power supply 1, in this order. When the side of the inductor L2 of the AC power supply 1 is at the positive potential, the input current is passed through a route of AC power supply 1→relay 2→inductor L2→primary winding of transformer 16 of current detection circuit 12→switching element Q2→diode D3→primary winding of transformer 15 of current detection circuit 11→inductor L1→AC power supply 1. The current passing through the inductors L1 and L2 can be restricted by a resistance of the contact of the relay 2.

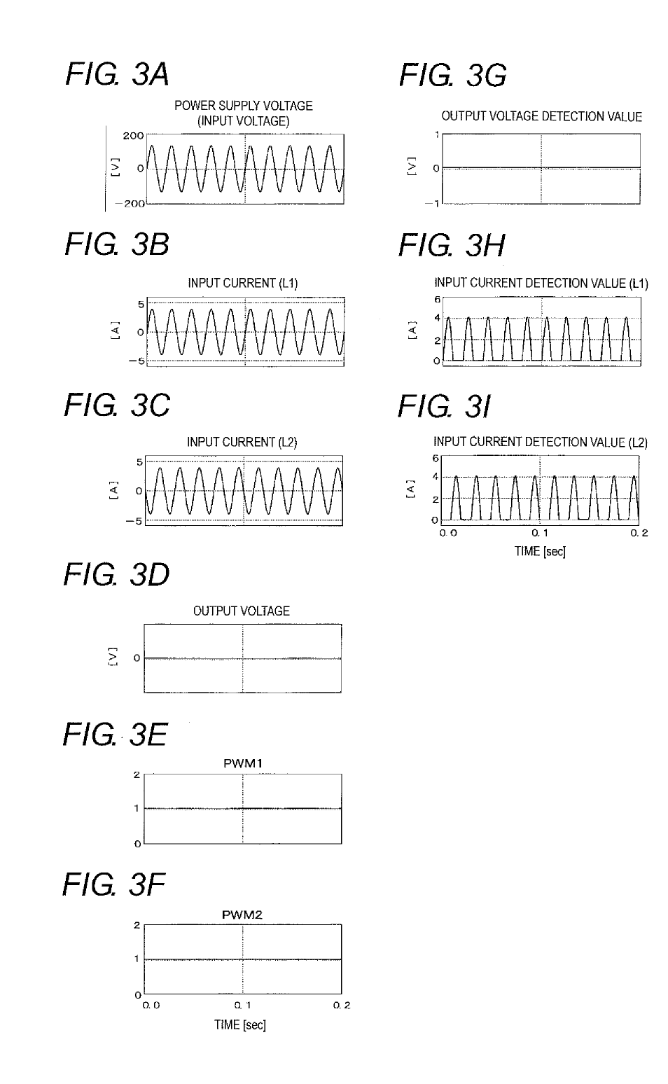

FIGS. 3A to 3F are views illustrating signal waveforms and current/voltage detection values of the parts in FIG. 2. FIG. 3A illustrates the voltage waveform (the waveform of the input voltage) of the AC power supply 1, FIG. 3B illustrates the waveform of the input current passing through the inductor L1, FIG. 3C illustrates the waveform of the input current passing through the inductor L2, FIG. 3D illustrates the waveform of the output voltage at the PFC circuit 100, FIG. 3E illustrates the waveform of the PWM signal applied to the gate of the switching element Q1 from the controller 200, FIG. 3F illustrates the waveform of the PWM signal applied to the gate of the switching element Q2 from the controller 200, FIG. 3G illustrates the voltage value of the output voltage detected by the voltage detection circuit 13, FIG. 3H illustrates the current value of the input current, which passes through the inductor L1 and detected by the current detection circuit 11, and FIG. 3I illustrates the current value of the input current, which is passing through the inductor L2 and detected by the current detection circuit 12. The currents passing through the inductors L1 and L2 have phases reversed to each other.

As can be seen from FIGS. 3A to 3C, in the state in which the switching elements Q1 and Q2 are fixed to the on state, the waveform of the input current passing through the thick-line route in FIG. 2 has the same shape as the waveform (the sine wave) of the input voltage. Therefore, the waveform of the input current is analyzed, and the input voltage is determined based on the analysis result, which allows normal PFC control to be performed based on the input voltage.

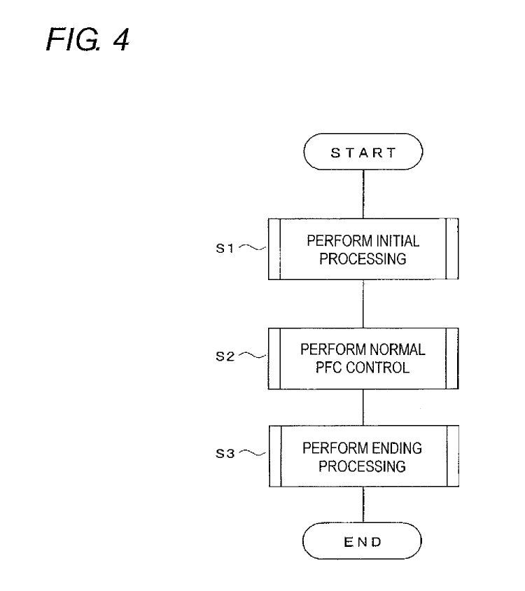

FIG. 4 is a flowchart illustrating a schematic control procedure performed by the controller 200. In Step S1, the controller 200 performs the initial processing. After the initial processing, the controller 200 performs the normal PFC control to the PFC circuit 100 in Step S2. When the normal PFC control is ended, the controller 200 performs predetermined ending processing to the PFC circuit 100 in Step S3. The detailed processing in each step will sequentially be described below.

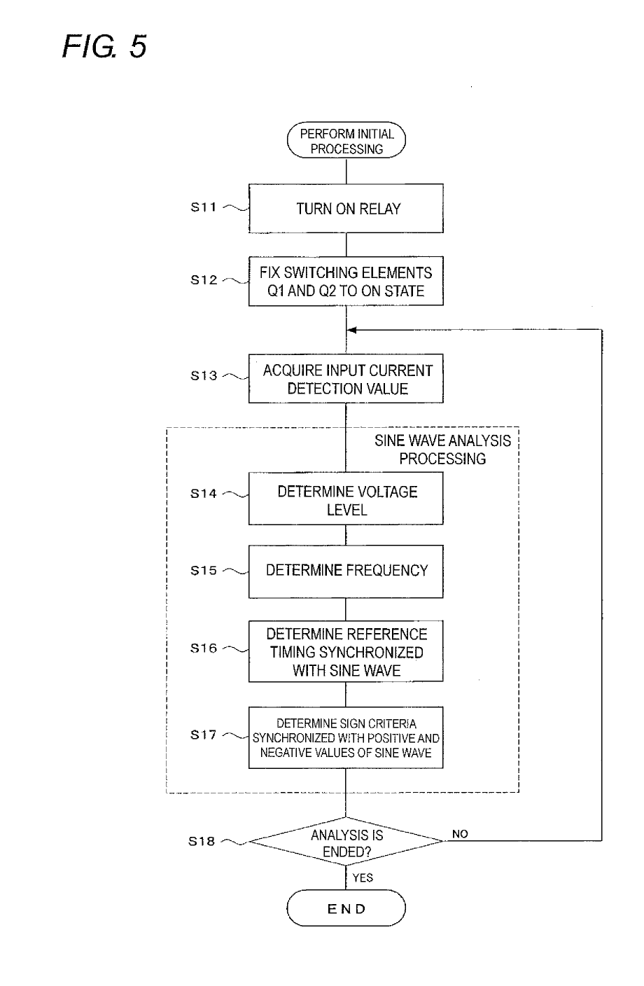

FIG. 5 is a flowchart illustrating the detailed procedure of the initial processing (Step S1 in FIG. 4). The controller 200 performs pieces of processing in the steps of FIG. 5. Next, in Step S11, the controller 200 turns on the relay 2 to close the contact. In Step S12, the controller 200 fixes the switching elements Q1 and Q2 to the on state. That is, as described above, the controller 200 outputs the H-level signal (the PWM signal having a duty ratio of 100%) to the gates of the switching elements Q1 and Q2, and puts the switching elements Q1 and Q2 into the state in which the switching elements Q1 and Q2 remain turned on (see FIG. 2).

Subsequently, in Step S13, the controller 200 acquires the input current detection values (FIGS. 3H and 3I) detected by the current detection circuits 11 and 12. Then the controller 200 performs sine wave analysis processing including a sequence of procedures in Steps S14 to S17. Through the sine wave analysis processing, the waveform of the detected input current is analyzed to determine four parameters (a voltage level, a frequency, reference timing, and a sign criterion) necessary to determine the input voltage. The same analysis technique as the conventional PFC circuit that monitors the input voltage can be applied to the pieces of processing in Steps S14 and S15, and the pieces of processing in Steps S16 and S17 are newly added in one or more embodiments of the present invention.

In Step S14, the controller 200 determines the voltage level of the input voltage based on the input current detection values acquired in Step S13. The input voltage and the input current can be formulated as the following simple relationship.

Vin=K·Iin+Vz (1)

Where Vin is the input voltage, Iin is the input current, K is a constant determined by circuit design, and Vz is a voltage drop due to the relay and the like. Vz may be omitted, because only the voltage level can be distinguished. From the equation (1), it is found that the analysis can be performed while the input current waveform is replaced with the input voltage waveform.

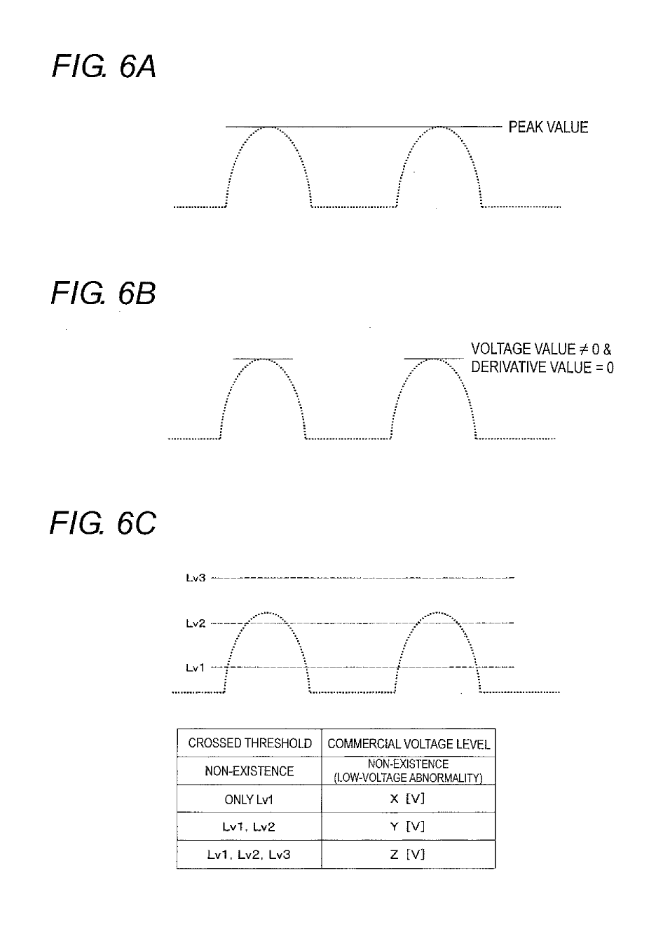

For example, the voltage level can be determined by methods in FIGS. 6A to 6C. FIG. 6A illustrates a method for determining the voltage level by selecting a peak value obtained by peak hold. FIG. 6B illustrates a method for determining the voltage level by selecting the value obtained at current value≠0 and current derivative value=0 (actually a range of ±1 is provided) (zero crossing of the current derivative value may be detected). FIG. 6C illustrates a method in which thresholds Lv1 to Lv3 are previously determined according to each commercial voltage and the voltage level is selected from a table by which threshold the current waveform crosses. In each method, desirably sampling is performed a plurality of times in at least two cycles to fix the voltage level by averaging or a majority vote compared with the case where the sampling is performed once at one cycle to fix the voltage level. In the case of at least two cycles, a determination interval may properly be set in the cycle longer than at least the maximum value of the commercial frequency. As needed basis, a calculation value may be reset during the determination interval.

In the methods, the maximum value of the input voltage is obtained. Assuming that the waveform of the commercial power supply is a complete sine wave, an effective value and an average value of the input voltage are automatically obtained from the following equations.

effective value of input voltage=maximum value/√2 of input voltage (2)

average value of input voltage=maximum value×2/π of input voltage (3)

Because these relationships are fixed, it is not necessary to calculate the effective value and the average value, but a table in which a calculation result corresponding to the maximum value is stored may be prepared. When the waveform of the commercial power supply cannot be assumed to be the complete sine wave (in the case of a large strain), the effective value and the average value may be calculated from a sampling value at each time by the calculation.

Referring to FIG. 5, in Step S15, the controller 200 determines the frequency of the input voltage from the waveform of the input current. As can be seen from FIGS. 3A to 3C, the frequency of the input voltage can be determined from the frequency of the input current because the frequency of the input voltage is equal to the frequency of the input current. In this case, like the voltage level, desirably the sampling is performed a plurality of times in at least two cycles to fix the frequency by the averaging or the majority vote compared with the case where the sampling is performed once at one cycle to fix the frequency. Because there are only two kinds of frequencies of 50 Hz and 60 Hz unlike the voltage level, required detection accuracy is not so high.

A method for detecting a clock time when the sine wave becomes the zero level to determine the frequency from the interval between the zero levels is conceivable as the simplest method. In the case where a full-wave rectifying bridge circuit is used, the frequency can be determined in the shortest time at a half cycle of the commercial power supply. In the case where a full-wave rectifying bridge circuit is not used as illustrated in FIG. 1, the full-wave rectification waveform is obtained by synthesizing the currents of the inductors L1 and L2.

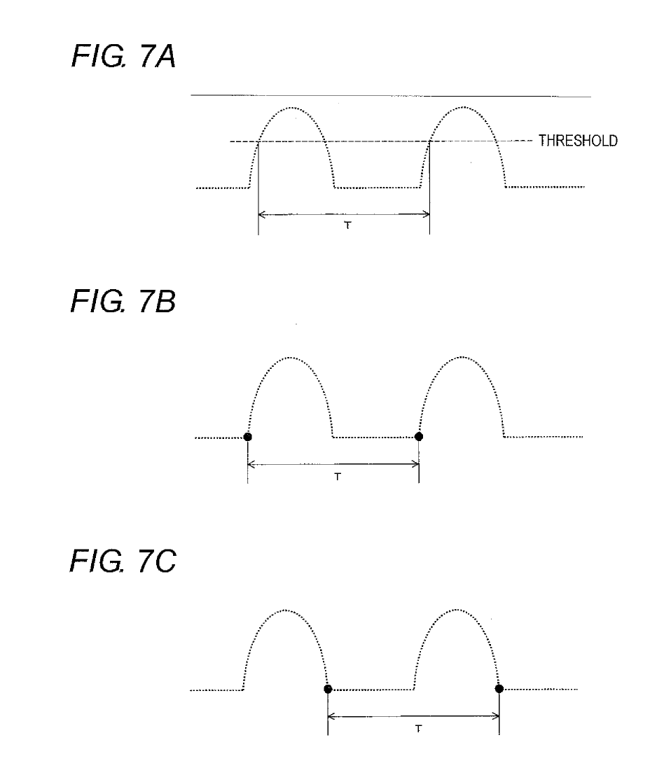

Additionally, as illustrated in FIGS. 7A to 7C, there are also methods for determining the frequency. FIG. 7A illustrates a method in which a clock time when the current waveform crosses an arbitrary constant threshold is detected to determine the frequency from a time difference between the current crossing time clock and the previous crossing clock time. In this case, the threshold is set less than the minimum commercial voltage. Because the crossing is detected in the voltage level analyses in FIGS. 6B and 6C, the frequency analysis may be performed at the same time as the crossing.

FIG. 7B illustrates a method for determining the frequency from the time difference T at a time when the current derivative value changes from zero to a positive value. FIG. 7C illustrates a method for determining the frequency from the time difference T at a time when the current derivative value changes from zero to a negative value. According to the methods, starting timing of one cycle of the sine wave is understood, so that the starting timing can be shared by the processing in Step S15 and reference timing setting processing (Step S16 in FIG. 5). The same effect as that in FIGS. 7B and 7C is obtained when the threshold is brought close to zero in FIG. 7A.

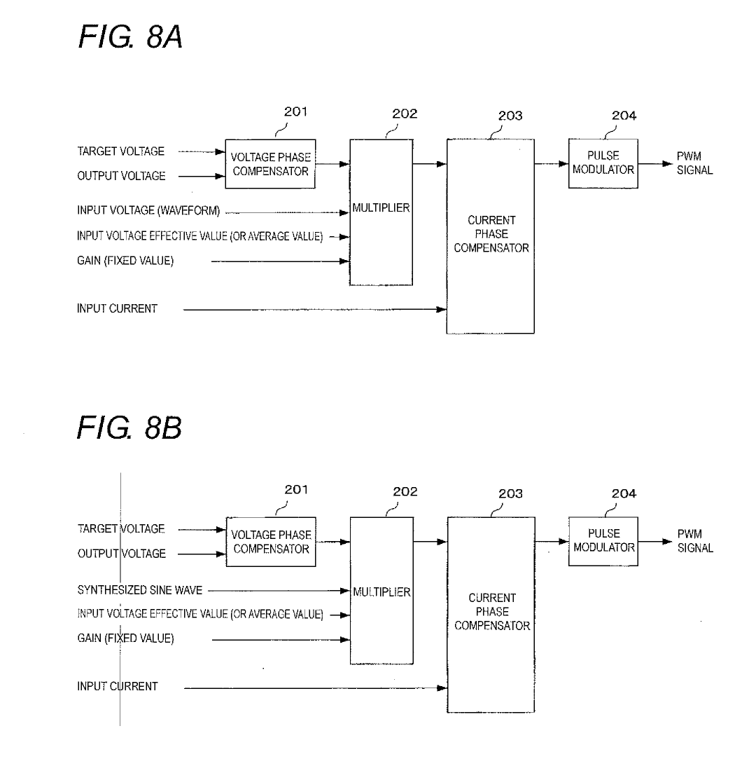

Referring to FIG. 5, in Step S16, the controller 200 determines reference timing synchronized with the sine wave. Prior to the description of the processing in Step S16, an outline of current continuous mode control performed by the PFC circuit 100 will be described with reference to FIGS. 8A and 8B. FIG. 8A is a functional block diagram illustrating a conventional configuration of the controller, and FIG. 8B is a functional block diagram illustrating a configuration of the controller according to one or more embodiments of the present invention.

A voltage phase compensator 201 compares the present output voltage at the PFC circuit 100 to a target voltage, and adjusts a control amount according to a deviation to perform voltage phase compensation. The output voltage is inputted from the voltage detection circuit 13 in FIG. 1. The target voltage is previously set in the controller 200, or provided from the outside. A multiplier 202 multiplies the output of the voltage phase compensator 201 and input voltage information to shape the sine wave. A current phase compensator 203 compares the present input current of the PFC circuit 100 to the output of the multiplier 202, and adjusts the control amount according to the deviation to perform current phase compensation. The input current is inputted from the current detection circuits 11 and 12 in FIG. 1. A pulse modulator 204 generates and outputs the PWM signal having the duty corresponding to the output of the current phase compensator 203. The PWM signal is provided to the gates of the switching elements Q1 and Q2 of the PFC circuit 100.

In the case of the conventional configuration in FIG. 8A, the input voltage (the waveform) detected by the input voltage detection circuit (not illustrated) is inputted to the multiplier 202. On the other hand, in the case of the configuration of the controller of one or more embodiments in FIG. 8B, because the input voltage detection circuit is not provided, but the synthesized sine wave generated based on the input current is inputted to the multiplier 202. The effective value (or the average value) of the input voltage is obtained by the equations (2) and (3). A gain is a predetermined fixed value (a constant).

In order to generate sine wave sin ωt (=sin 2 πft), it is necessary to obtain two pieces of information, namely, the frequency f and reference timing t that can be synchronized with the sine wave of the input voltage. Because the frequency f is already fixed in Step S15 of FIG. 5, a method for determining the reference timing t will be described below.

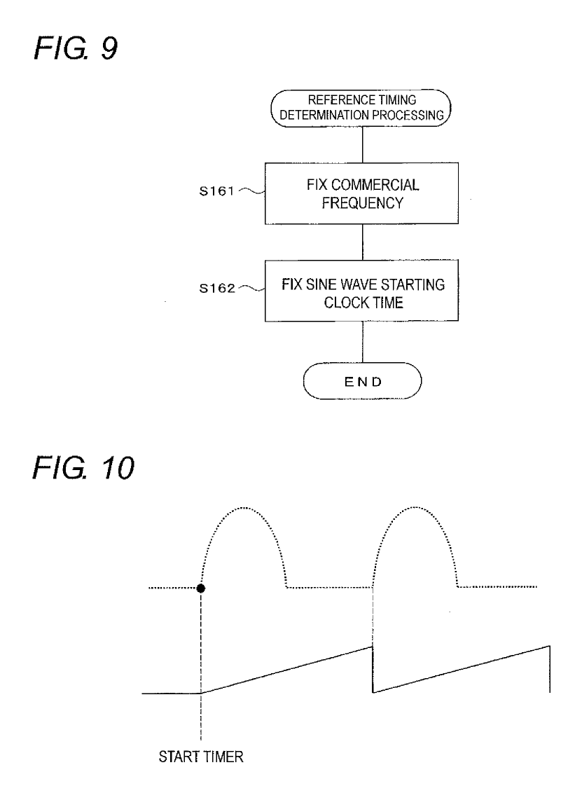

FIG. 9 is a flowchart illustrating a procedure of the reference timing determination processing (Step S16 in FIG. 5). The controller 200 performs pieces of processing in the steps of FIG. 9. In Step S161, the controller 200 fixes the commercial frequency (50 Hz or 60 Hz). The commercial frequency is fixed according to the frequency determination processing in FIGS. 7A to 7C. In Step S162, the controller 200 fixes a sine wave starting clock time. Similarly the sine wave starting clock time may be fixed in the frequency determination processing.

In the case where frequency fixing processing is performed by a method for detecting a zero point of the input current, the clock time at the zero point is stored as the reference timing. In generating and acquiring the clock time, for example, as illustrated in FIG. 10, a timer may be started up at the zero point to generate a saw-tooth wave that is reset every cycle or every half cycle of the commercial power supply. Alternatively, a reference clock is provided in the controller 200, and the clock time indicated by the reference clock at the zero point of the input current may be acquired. The reference timing may be fixed once determined, or the reference timing may be updated under a given condition. A method for updating the reference timing is described later.

Referring to FIG. 5, in Step S17, the controller 200 determines sign criteria synchronized with positive and negative values of the sine wave. In the PFC circuit 100 according to one or more embodiments of the present invention, because the full-wave rectification is not performed, it is necessary to perform the control according to the positive and negative values of the sine wave during the normal PFC operation. For example, in detecting the input current, it is necessary to switch the current detection circuits 11 and 12 according to the positive and negative values of the sine wave (the current detection circuit 11 for the positive value, and the current detection circuit 12 for the negative value). However, in the case where both the currents are always monitored, the full-wave rectification waveform is obtained by synthesizing the currents. Therefore, the necessity of the switching control is eliminated. For example, the switching control is required in the case where a channel of the A/D converter is shared. It is also necessary to switch the switching operations of the switching elements Q1 and Q2 according to the positive and negative values of the sine wave (the switching element Q1 for the positive value, and the switching element Q2 for the negative value). It is necessary to perform the switching control. The switching element that does not perform the switching operation may be fixed to the on state or off state. Desirably the switching element that does not perform the switching operation is fixed to the on state in which a conduction loss is decreased.

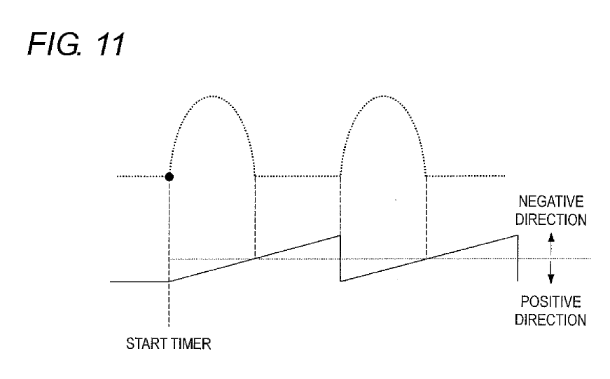

The current passing through the inductor L1 (the current detected by the current detection circuit 11) is a positive direction and the current passing through the inductor L2 (the current passing through the current detection circuit 12) is a negative direction, so that the positive and negative values of the sine wave can be determined by the current passing through the inductor L1 or L2. For example, in the case of the current passing through the inductor L1, as illustrated in FIG. 11, the saw-tooth wave generated in the reference timing determination processing is generated at the commercial frequency, the sine wave can be determined to be the positive direction when existing within the half cycle of the saw-tooth wave, and the sine wave can be determined to be the negative direction when exceeding the half cycle. Alternatively, a pulse that is toggled every half cycle may be generated with the timer.

Referring to FIG. 5, in Step S18, the controller 200 determines whether the analysis is ended after the sine wave analysis processing in Steps S14 to S17 is performed. When the analysis is ended (YES in Step S18), the controller 200 ends the initial processing to make a transition to the normal PFC control (Step S2 in FIG. 4). When the analysis is not ended (NO in Step S18), the flow returns to Step S13, the pieces of processing in Steps S13 to S17 are repeated until all items to be fixed are fixed in the sine wave analysis processing.

Through the initial processing, the parameters relating to the input voltage at the PFC circuit 100 are determined based on the input current. In the subsequent normal PFC control, the synthesized sine wave of the input voltages is generated based on the determined parameters, and the PFC control is performed using the sine wave.

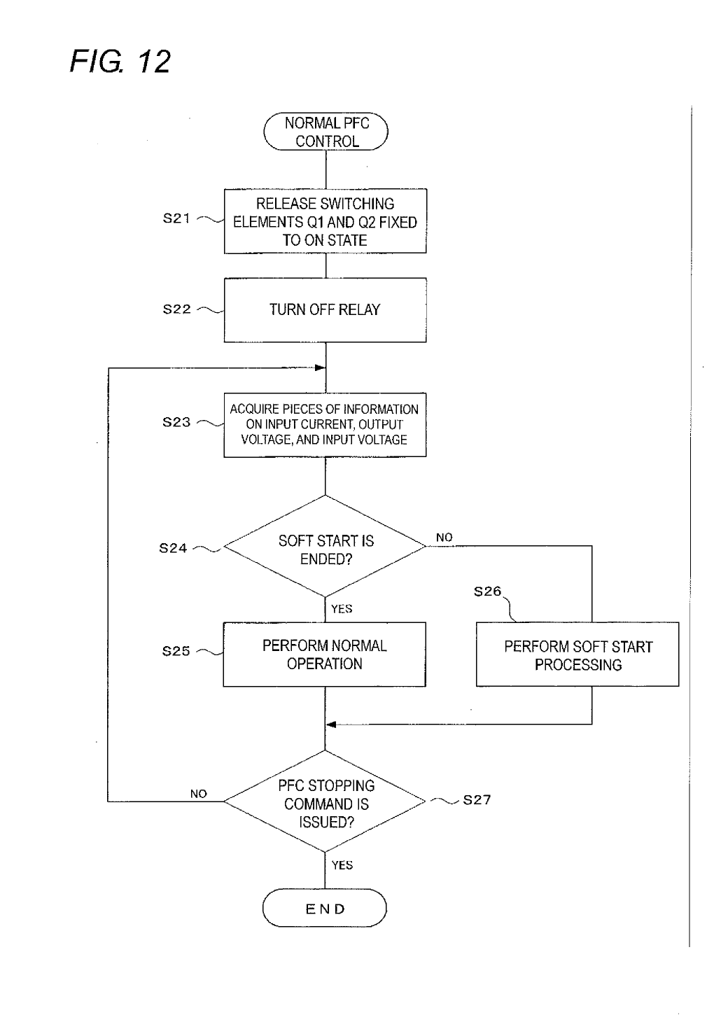

The normal PFC control in Step S2 of FIG. 4 will be described below. The normal PFC control in Step S2 is basically identical to that of the conventional normal PFC control except the synthesized sine wave. FIG. 12 is a flowchart illustrating the detailed procedure of the normal PFC control after the initial processing. The controller 200 performs pieces of processing in the steps of FIG. 12.

In Step S21, the controller 200 outputs an L-level signal (the PWM signal having the duty of 0%) to each of the gates of the switching elements Q1 and Q2, and releases the switching elements Q1 and Q2 fixed to the on state. Therefore, the switching elements Q1 and Q2 becomes the off state. In Step S22, the controller 200 turns off the relay 2 to open the contact. The current route indicated by the thick line in FIG. 2 is released through the pieces of processing in Steps S21 and S22. In Step S23, the controller 200 acquires the pieces of information on the input currents detected by the current detection circuits 11 and 12, the output voltage detected by the voltage detection circuit 13, and the input voltage determined based on the input current.

Then, the controller 200 turns on the relay 2 again to start soft starting processing (Step S26), and gradually brings control amounts of the switching elements Q1 and Q2 to target voltage values. When the soft starting is ended (YES in Step S24), the flow goes to Step S25, and the controller 200 switches the normal PFC control to a normal operation such as current continuous mode control. Then, the controller 200 performs the processing in FIGS. 8A and 8B to generate the PWM signal, and controls the on/off operations of the switching elements Q1 and Q2 using the PWM signal. The normal PFC control is repeated until some sort of event is generated to issue a PFC stopping command in Step S27.

The normal PFC control according to one or more embodiments of the present invention differs from the conventional normal PFC control in that self-synthesis is performed to the sine wave inputted to the multiplier 202 in FIG. 8B. Because the method for determining the parameters necessary to generate the sine wave is already described, a method for synthesizing the sine wave in the controller 200 will be described below. Examples of the method for synthesizing the sine wave are described below.

### (1) Method for Directly Calculating the Sine Wave

A standard mathematical function library provided from a vender of an MCU (Micro Control Unit) is used. Although the method has the high accuracy, unfortunately a calculation cost (time) increases.

### (2) Method for Approximately Calculating the Sine Wave

The sine wave is approximately calculated using Tayler's expansion or Maclaurin's expansion. The following equation is an example of the Maclaurin's expansion.

$$\begin{matrix}[ Mathematical formula 1 ] & \\ sin ωt = ωt - \frac{1}{3 !} {( ωt )}^{3} + \frac{1}{5 !} {( ωt )}^{5} - \frac{1}{7 !} {( ωt )}^{7} + … & ( 4 )\end{matrix}$$

In the method, the calculation may be performed to an order of an extent to which required performance is ensured, and power calculation of each order may be possessed as a constant. Therefore, the accuracy and the calculation cost can be controlled. A table of ω for t may be produced.

(3) Method in which a Clock Time-Sine Wave Output Table is Used

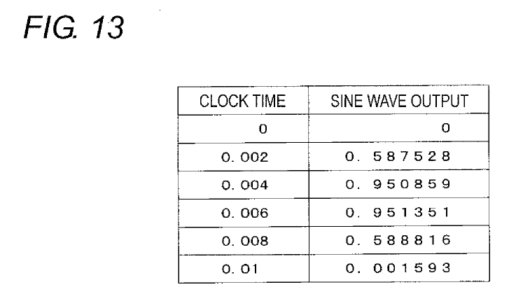

A table of the sine wave output for the clock time of one or half cycle is previously prepared. FIG. 13 illustrates an example (an example of the half cycle at 50 Hz). The number of samplings of the table is determined according to the required performance. The sampling may be performed at equal intervals, or the sampling interval may be thickened only around a vertex of the sine wave. For example, the value that does not exist in the table may be determined by linear interpolation.

In the methods (1) to (3), it is not necessary to prepare the table in each voltage level, but a common reference sine wave may be multiplied by the gain of each voltage level.

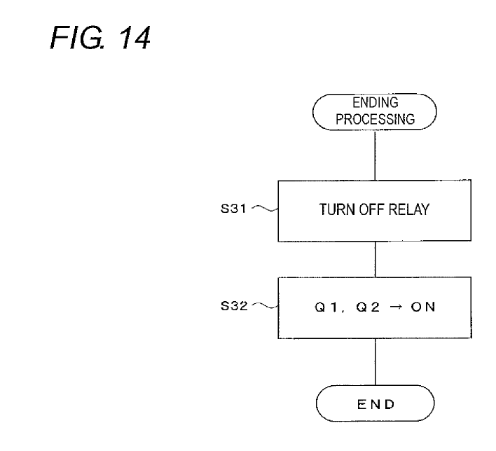

The ending processing in Step S3 of FIG. 4 will be described below. FIG. 14 is a flowchart illustrating a procedure of the ending processing. The controller 200 performs pieces of processing in the steps of FIG. 14. In Step S31, the controller 200 initially turns off the relay 2 in order to prevent the large current. In Step S32, the controller 200 turns on both the switching elements Q1 and Q2. Therefore, the ending processing is completed. Desirably normally-on type switching elements are used as the switching elements Q1 and Q2 and a normally-off type relay is used as the relay 2. When the normally-on type switching elements are used as the switching elements Q1 and Q2, the current does not pass through the output terminal even if the power supply of the PFC circuit 100 disappears, so that generation of a harmonic can be prevented. When the normally-off type relay is used as the relay 2, the current is restricted even if the power supply of the PFC circuit 100 disappears, so that the large current can be prevented.

A method for updating the reference timing of the sine wave will be described below. The updating method includes a method in which the reference timing is updated while the PFC operation is stopped and a method in which the reference timing is updated while the PFC operation is continued.

(1) Method in which the Reference Timing is Updated while the PFC Operation is Stopped

The ending processing (Step S3 in FIG. 4, and FIG. 14) is performed to stop the PEG operation, and the processing is restarted from the initial processing (Step S1 in FIG. 4, and FIG. 5). For example, in the case of the PFC circuit 100 used in a charging device of a battery, the charge is temporarily stopped. Although generally it takes several hours to complete a charging operation, the charge temporarily stopping time necessary to update the reference timing is no longer than several seconds. Therefore, for example, even if the charge is temporarily stopped once every several minutes, the charge temporarily stopping time is moment from the viewpoint of whole charge time, and therefore the charge temporarily stopping time does not disturb the charging operation.

(2) Method in which the Reference Timing is Updated while the PFC Operation is Continued

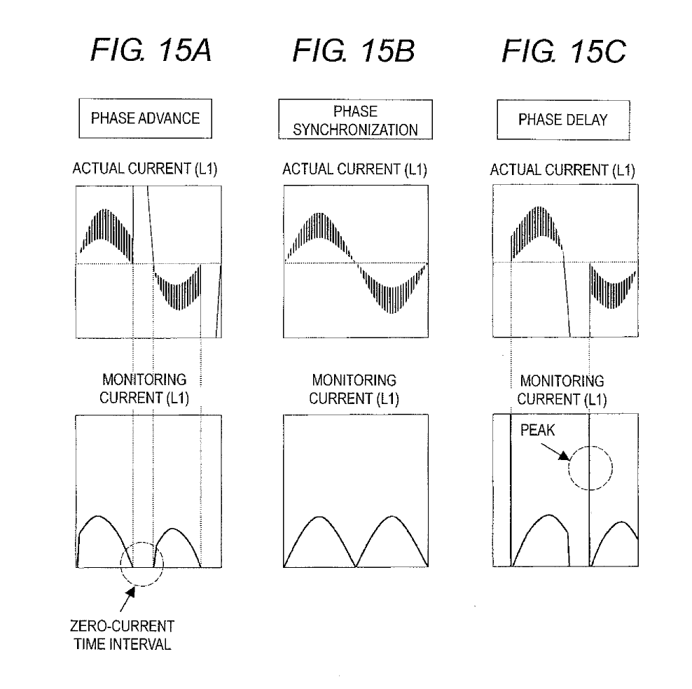

The controller 200 monitors the current waveforms of the inductors L1 and L2 based on the outputs of the current detection circuits 11 and 12, and the controller 200 corrects the reference timing when the current waveform collapses from the sine wave (when the phase is shifted). When the phase of the synthesized sine wave is advanced or delayed, the current waveform changes as illustrated in FIGS. 15A to 15C. In FIGS. 15A to 15C, each upper part illustrates the current actually passing through the inductor L1, and each lower part illustrates the current monitored by the controller 200. FIG. 15A illustrates the case where the phase is advanced, FIG. 15B illustrates the case where the phase is synchronized, and FIG. 15C illustrates the case where the phase is delayed.

When the phase of the synthesized sine wave is shifted as illustrated in FIGS. 15A and 15C, the current waveform becomes discontinuous to generate a zero time interval or a peak. Accordingly, for example, the phase shifting can easily be detected by continuously monitoring the waveform. A tendency and a degree of the discontinuity depend on a shifting direction and a shifting amount of the phase, so that a correction direction and a correction amount of the reference timing can be determined. For example, the current zero time interval emerges when the phase is advanced as illustrated in FIG. 15A. Therefore, the correction may be performed such that the phase is delayed. The peak emerges when the phase is delayed as illustrated in FIG. 15C. Therefore, the correction may be performed such that the phase is advanced.

In the case where the currents of the inductors L1 and L2 are monitored by monitoring the currents of the switching elements Q1 and Q2, the actual current waveform becomes a pulse string. This is because the switching elements Q1 and Q2 become the open state in the off state not to detect the currents. In this case, the current of one of the switching elements Q1 and Q2, which is turned on, is generally monitored, and therefore the same processing can be applied.

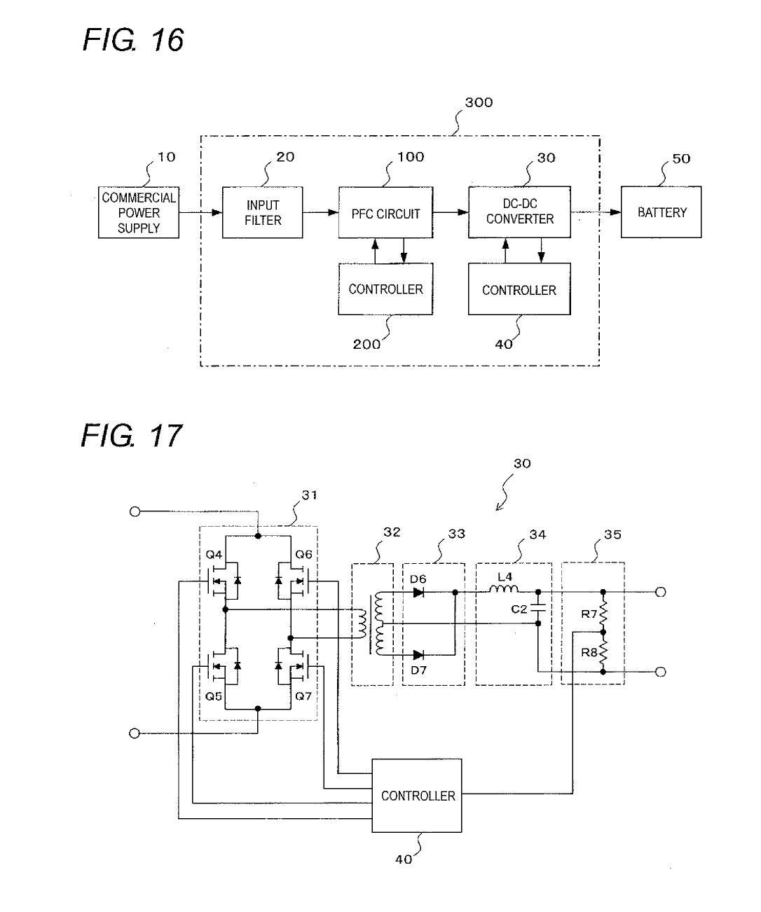

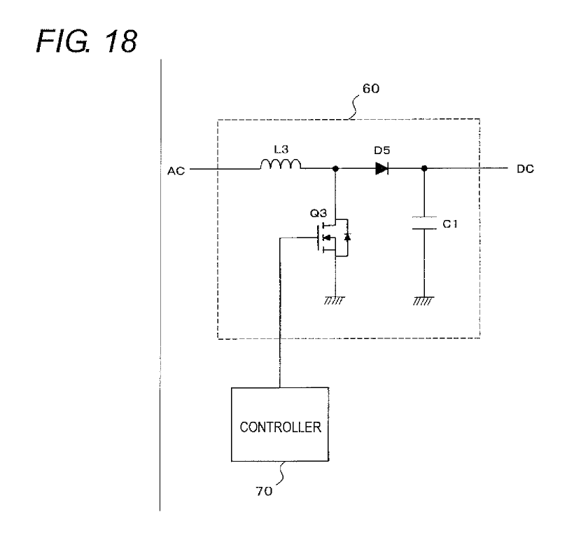

FIG. 16 is a block diagram when one or more embodiments of the present invention is applied to the charging device. A charging device 300 is mounted on a vehicle, and converts an AC voltage supplied from an external commercial power supply 10 into a DC voltage used to charge the battery 50. A battery 50 is constructed by a secondary battery such as a lithium-ion battery and a lead storage battery, and charged by the DC voltage outputted from the charging device 300. The voltage at the battery 50 is supplied to a motor (not illustrated) that drives the vehicle.

The charging device 300 includes an input filter 20, the PFC circuit 100 and controller 200 of one or more embodiments of the present invention, a DC-DC converter 30, and a controller 40. The input filter 20 removes a noise from the AC voltage of the commercial power supply 10, and protects the circuit against a lightning surge. The PFC circuit 100 and the controller 200 are identical to those in FIG. 1. The DC-DC converter 30 performs DC-DC conversion to the DC voltage outputted from the PFC circuit 100 through the switching operation, and generates the DC voltage used to charge the battery 50. The controller 40 controls the operation of the DC-DC converter 30.

FIG. 17 illustrates an example of the DC-DC converter 30. The DC-DC converter 30 is a well-known circuit including a switching circuit 31, a transformer 32, a rectifier circuit 33, a smoothing circuit 34, and an output voltage detection circuit 35. The controller 40 is constructed by a microcomputer.

The switching circuit 31 includes four switching elements Q4 to Q7 in which bridge connection is formed, and the switching circuit 31 converts the DC voltage outputted from the PFC circuit 100 into the AC voltage. For example, the switching elements Q4 to Q7 are constructed by MOS-FETs. The transformer 32 boosts or steps down the AC voltage outputted from the switching circuit 31. The rectifier circuit 33 is constructed by two diodes D6 and D7, and converts the AC voltage generated on the secondary side of the transformer 32 into the pulsed DC voltage. The smoothing circuit 34 is constructed by a lowpass filter including an inductor L4 and a capacitor C2. The smoothing circuit 34 smoothes the voltage outputted from the rectifier circuit 33. The output voltage detection circuit 35 is constructed by series-connected divider resistors R7 and R8. The output voltage detection circuit 35 detects the output voltage at the smoothing circuit 34, and transmits the output voltage to the controller 40. The controller 40 performs feedback control based on the output voltage detected by the output voltage detection circuit 35, and controls the on and off operations of the switching elements Q4 to Q7 of the switching circuit 31.

According to one or more embodiments of the present invention, during the start-up of the PFC circuit 100, the controller 200 analyzes the waveform of the input current, determines the input voltage based on the analysis result, and controls the PFC circuit 100 based on the input voltage. Therefore, even if the voltage detection circuit that detects the input voltage is not provided, the input voltage is determined using the originally-provided input current detection circuits 11 and 12, and the desired PFC operation can be performed. Accordingly, unlike the conventional technology, it is not necessary to provide the components such as the isolated amplifier, and it is not necessary to ensure the insulation distance.

Various embodiments can be made in addition to the above embodiments. In one or more embodiments of the present invention, by way of example, the input voltage is determined based on the analysis result of the input current waveform. Alternatively, the input voltage may be determined based on the analysis result of the output voltage waveform. In this case, the controller 200 determines the input voltage based on the output of the voltage detection circuit 13 (see FIG. 1).

Particularly, in the initial processing during the start-up of the PFC circuit 100, the controller 200 fixes the switching elements Q1 and Q2 to the off state. At this point, the controller 200 analyzes the waveform of the output voltage generated by the currents passing through resistors R5 and R6 of the voltage detection circuit 13 from the AC power supply 1 based on the output of the voltage detection circuit 13, and determines the input voltage at the PFC circuit 100 based on the analysis result. After the initial processing, the controller 200 controls the on/off operations of the switching elements Q1 and Q2 based on the determined input voltage, the input currents detected by the current detection circuits 11 and 12, the output voltage detected by the voltage detection circuit 13.

In this case, because the sine wave cannot be taken out unless the load 3 has a proper resistance value, it is necessary to provide a mechanism that controls the load amount when viewed from the output terminal of the PFC circuit 100. For example, in the case of the single PFC circuit 100 (see FIG. 1), it is conceivable that a small-value resistor is disposed in parallel with the load 3, and that the small-value resistor is switched between the on and off states. In the case where the PFC circuit 100 is incorporated in the charging device 300 (see FIG. 16), it is conceivable that the switching elements Q4 to Q7 (see FIG. 17) are fixed to the on state in the DC-DC converter 30 at the subsequent stage of the PFC circuit 100, and that the bridge is put into conduction.

In one or more of the above embodiments, the half-wave rectification is performed using the diodes D1 and D2. Alternatively, the full-wave rectification may be performed using the four diodes. In the case of the full-wave rectification, the necessity of sign criterion determination processing (Step S17 in FIG. 5) is eliminated because the necessity of the information on the positive and negative value of the sine wave is eliminated in the PFC control.

In one or more of the above embodiments, the switching elements Q1 and Q2 are provided to construct the interleave type including two switching circuit systems. Alternatively, only one switching element may be provided to construct a single type including one switching circuit system.

In one or more of the above embodiments, by way of example, the switching elements Q1 and Q2 are driven using the PWM signal. Alternatively, the switching elements Q1 and Q2 may be driven using a pulse signal that is not the PWM signal.

In one or more of the above embodiments, by way of example, the boost type PFC circuit 100 boosts the input voltage. However, one or more embodiments of the present invention can also be applied to a step-down type PFC circuit that steps down the input voltage.

In one or more of the above embodiments, by way of example, the current continuous mode is cited as an example of the control system of the PFC circuit 100. Additionally, a current critical mode or a current discontinuous mode may be used.

Above, by way of example, one or more embodiments the present invention is applied to the charging device 300. However, one or more embodiments of the present invention can be used in applications other than the charging device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A power factor correction circuit controlling device comprising:
a power factor correction circuit that is connected to an AC power supply, and brings a waveform of an input current from the AC power supply close to a sine wave to correct a power factor by an on/off operation of a switching element; and
a controller that controls an operation of the power factor correction circuit,
wherein the power factor correction circuit includes: a current detection circuit that detects the input current; and a voltage detection circuit that detects the output voltage at the power factor correction circuit,
wherein, during start-up of the power factor correction circuit, the controller fixes the switching element to an on state, analyzes the waveform of the input current passing through the switching element from the AC power supply based on an output of the current detection circuit, and performs initial processing of determining an input voltage at the power factor correction circuit based on the analysis result, and
wherein, after the initial processing, the controller controls the on/off operation of the switching element based on the determined input voltage, the input current detected by the current detection circuit, and the output voltage detected by the voltage detection circuit.

2. The power factor correction circuit controlling device according to claim 1, wherein the controller determines a voltage level, a frequency, and reference timing synchronized with the sine wave with respect to the input voltage when analyzing the waveform of the input current.

3. The power factor correction circuit controlling device according to claim 2, wherein the controller further determines sign criteria synchronized with positive and negative values of the sine wave with respect to the input voltage when analyzing the waveform of the input current.

4. The power factor correction circuit controlling device according to claim 2, wherein, in determining the reference timing, the controller fixes a starting clock time of the sine wave after fixing a commercial frequency.

5. The power factor correction circuit controlling device according to claim 1, wherein the controller includes:
a voltage phase compensator that compares the present output voltage at the power factor correction circuit to a target voltage, and performs voltage phase compensation based on a deviation between the present output voltage and the target voltage;
a multiplier that shapes the sine wave based on an output of the voltage phase compensator and the input voltage;
a current phase compensator that compares a present input current of the power factor correction circuit to an output of the multiplier, and performs current phase compensation based on a deviation between the present input current and the output of the multiplier; and
a pulse modulator that generates a PWM signal having a duty corresponding to an output of the current phase compensator, and outputs the PWM signal to the switching element.

6. The power factor correction circuit controlling device according to claim 2, wherein the controller updates the determined reference timing under a given condition.

7. The power factor correction circuit controlling device according to claim 6, wherein the controller monitors the waveform of the input current based on the output of the current detection circuit, and corrects phase shifting to update the reference timing when a phase is advanced or delayed in the current waveform.

8. A power factor correction circuit controlling device comprising:
a power factor correction circuit that is connected to an AC power supply, and brings a waveform of an input current from the AC power supply close to a sine wave to correct a power factor by an on/off operation of a switching element; and
a controller that controls an operation of the power factor correction circuit,
wherein the power factor correction circuit includes: a current detection circuit that detects the input current; and a voltage detection circuit that detects the output voltage at the power factor correction circuit,
wherein, during start-up of the power factor correction circuit, the controller fixes the switching element to an off state, analyzes a waveform of the output voltage generated by a current passing through the voltage detection circuit from the AC power supply based on an output of the voltage detection circuit, and performs initial processing of determining an input voltage at the power factor correction circuit based on the analysis result, and
wherein, after the initial processing, the controller controls the on/off operation of the switching element based on the determined input voltage, the input current detected by the current detection circuit, and the output voltage detected by the voltage detection circuit.

9. A charging device comprising:
the power factor correction circuit controlling device according to claim 1; and
a DC-DC converter that generates a charging DC voltage by performing DC-DC conversion of a voltage outputted from the power factor correction circuit.

10. A charging device comprising:
the power factor correction circuit controlling device according to claim 2; and
a DC-DC converter that generates a charging DC voltage by performing DC-DC conversion of a voltage outputted from the power factor correction circuit.

11. A charging device comprising:
the power factor correction circuit controlling device according to claim 3; and
a DC-DC converter that generates a charging DC voltage by performing DC-DC conversion of a voltage outputted from the power factor correction circuit.

12. A charging device comprising:
the power factor correction circuit controlling device according to claim 4; and
a DC-DC converter that generates a charging DC voltage by performing DC-DC conversion of a voltage outputted from the power factor correction circuit.

13. A charging device comprising:
the power factor correction circuit controlling device according to claim 5; and
a DC-DC converter that generates a charging DC voltage by performing DC-DC conversion of a voltage outputted from the power factor correction circuit.

14. A charging device comprising:
the power factor correction circuit controlling device according to claim 6; and
a DC-DC converter that generates a charging DC voltage by performing DC-DC conversion of a voltage outputted from the power factor correction circuit.

15. A charging device comprising:
the power factor correction circuit controlling device according to claim 7; and
a DC-DC converter that generates a charging DC voltage by performing DC-DC conversion of a voltage outputted from the power factor correction circuit.

16. A charging device comprising:
the power factor correction circuit controlling device according to claim 8; and
a DC-DC converter that generates a charging DC voltage by performing DC-DC conversion of a voltage outputted from the power factor correction circuit.
